(19) United States
(12) Patent Application Publication
(10) Pub. No.: US 2008/0291816 A1
(43) Pub. Date: Nov. 27, 2008

(54) Optical Recording Medium

(76) Inventors: Yuki Nakamura, Tokyo (JP); Tohru Yashiro, Kanagawa (JP); Tatsuo Mikami, Kanagawa (JP)

Correspondence Address: COOPER & DUNHAM, LLP, 1185 AVENUE OF THE AMERICAS, NEW YORK, NY, 10036, US

(21) Appl. No.: 11/884,168

(22) PCT Filed: Mar. 16, 2006
(86) PCT No.: PCT/JP2006/305766

§ 371 Date: Apr. 25, 2008

(30) Foreign Application Priority Data
Mar. 17, 2005 (JP) 2005-077168

(51) Int. Cl. G11B 7/00

(52) U.S. Cl. 369/284; 369/283; 369/288

(57) ABSTRACT

The object of the present invention is to provide an optical recording medium which includes a substrate, a first information layer and a second information layer, the first information layer and the second information layer are disposed on the substrate through an intermediate layer in a laminar structure; recording and reproducing is performed on each of the two information layers by laser beam irradiation from the first information layer side; the second information layer is provided with at least a reflective layer, a dielectric layer, and a second dye recording layer formed in this order; and the dielectric layer is formed from any one of materials selected from the group consisting of oxides, nitrides, sulfides, carbides or mixtures thereof from any one of elements which are not same as metal elements and semi-metal elements used for forming the reflective layer.

### TECHNICAL FIELD

The present invention relates to a recordable optical recording medium on which information can be recorded and reproduced by irradiating the recording layers with an optical beam to induce optical changes in transmittance, reflectance and the like on the recording layers, and the present invention is particularly applicable to two-layered DVD (Digital Video Disc or Digital Versatile Disc).

### BACKGROUND ART

Recently, in addition to optical recording media such as read-only DVD-ROM (Digital Versatile Disc-Read Only Memory), recordable DVD such as DVD+RW, DVD+R, DVD-R, DVD-RW, and DVD-RAM are put into practical use. These DVD+R and DVD+RW or the like are positioned as an extension of technologies of conventional recordable CD-R and CD-RW (Rewritable compact disc) and are designed to bring the recording densities (track pitch, and mark length of signals) and the substrate thicknesses into line with CD conditions to DVD conditions.

For example, DVD+R employs, as is the case with CD-R, the structure where an optical recording layer is formed on a substrate by spin-coating by use of a cyanine dye and/or an azo metal chelate dye, then a metal reflective layer is formed on the optical recording layer to form a substrate for recording information, and another substrate formed similarly to the substrate for recording information is bonded to the substrate for recording information through a bonding material. In this case, dye-based materials are typically used for the optical recording layer. One of the characteristics of CD-R is that CD-R has a high-reflectance of 65%, which satisfies the CD standard. This is because in order to obtain high-reflectance with the above-noted laminar structure, the optical absorption layer needs to satisfy a specific complex refractive index at wavelengths of recording beams and reproducing beams, and the optical absorption property of dyes are suitable for the conditions. Same applies to DVD.

By the way, in order to increase storage capacity of read-only DVD, those having two information layers have been proposed. FIG. 1 is a cross-sectional view showing a laminar structure of a DVD having such two information layers. In FIG. 1, first substrate 21 and second substrate 22 are bonded together through transparent intermediate layer 25 which is formed from an ultraviolet curable resin. On the inner side surface of the first substrate 21, translucent layer 23 being a first information layer is formed, and on the inner side surface of the second substrate 22, reflective layer 24 being a second information layer is formed. The translucent layer is formed from a dielectric layer or a thin metal layer, and the reflective layer 24 is formed from a metal layer. The translucent layer 23 has concave-convex-shaped recording marks formed thereon to thereby read recording signals by means of effect of reflecting and interfering in reproduced laser beams. Since the read-only DVD reads recording signals from two information layers, a storage capacity up to around 8.5 GB can be obtained. The first substrate 21 and the second substrate 22 respectively have a thickness of 0.6 mm, and the transparent intermediate layer 25 has a thickness of around 50 μm. The first information layer is formed so as to have a reflectance of around 30%. A laser beam used for irradiation to reproduce information on the second information layer is reflected to the first information layer in an amount of around 30% of the entire optical quantity, attenuated, and then reflected to the second information layer, further subjected to attenuation again at the first information layer and then moves outside the disc. The way that the focal point of a laser beam for reproducing is focused on the first information layer or the second information layer to detect the reflected beams enables reproducing signals recorded on each of the information layers. It is noted that the wavelength of laser beams used for recording and reproducing information on DVD is approximately 650 nm.

In the above-mentioned recordable DVD i.e. DVD+R, DVD-R, DVD-RW, and DVD+RW, there are only discs having a single information layer on which information is readable from the single-side thereof, and in order to obtain larger storage capacities on these optical recoding media, there is a need to make a disc so as to reproduce information from both sides thereof. On the contrary, in optical recording media of single-sided two-layered recording and reproducing type, when the focal point of a recording laser beam is irradiated onto and focused on the innermost information layer or the second information layer through a optical pick-up to record signals, it is impossible to gain sufficient optical absorption and optical reflectance enough to record information on the second information layer because the first information layer has already attenuated the laser beam.

For example, Patent Literature 1 proposes an optical recording medium which is configured to enable recording information on two information layers made from an organic dye from the single-side of the optical recording medium at the time of recording as well as to read recorded information on the two information layers from the single-side of the optical recording medium at the time of reproducing. However, the invention remains to have only a laminar structure of which two types substrates of a conventional recording structure of beam irradiation from a substrate surface and a recording structure of beam irradiation from a recording layer surface are bonded together, and this cannot resolve the above-mentioned problems relating to optical absorption and reflectance of the second information layer.

In addition, Patent Literature 2 describes a laminar structure provided with a metal reflective layer, a dye-containing recording layer, and a protective layer. Patent Literature 2 describes that SiO, and SiO₂ may be used for materials of an organic protective layer, however, there are no specific preparation conditions and necessary optical properties for carrying out the invention.

Patent Literature 1 Japanese Patent Application Laid-Open (JP-A) No. 11-066622

Patent Literature 2 Japanese Patent Application Laid-Open (JP-A) No. 10-340483

### DISCLOSURE OF THE INVENTION

It is therefore an object of the present invention to provide an optical recording medium which has a first information layer and a second information layer and is capable of obtaining proper recording signal properties from not only the first information layer but also from the second information layer disposed at the innermost side as viewed from the laser beam irradiation side and is capable of recording and reproducing information on the single side of the disc.

In a typical optical recording medium having a dye-based recording layer prepared by spin-coating method, the thickness of the dye layer formed on concave portions on the substrate is thicker than that of the dye layer formed on convex portions on the substrate, and when information is recorded on one of the concave portions each of which is a recording track, spreading of a pit toward adjacent tracks can be prevented by thermal insulation effect of the convex portions. However, like the optical recording medium of the present invention, when an optical recording medium includes convex portions of a wobble formed (further includes address information in accordance with the necessity) on the surface of a second substrate, and a second information layer formed on the second substrate is provided with at least a reflective layer, a dielectric layer, a second dye recording layer, and a protective layer in this order, and when information is recorded on the convex portions of the second substrate as a recording track, in order to obtain an adequate signal amplitude and an adequate reflectance, there is a need to make the average thickness of the dye recording layer thicker than in the case where information is typically recorded on concave portions. In addition, when information is recorded on consecutive tracks, heat from irradiation of a recording laser beam, and heat generated at the time of decomposition of dye spreads over adjacent tracks, which causes a phenomenon that the jitter value is increased, and the quality of wobble signals degrades, because the thickness of the dye recording layer formed on the convex portions is substantially equal to or slightly thinner than that of the dye recording layer formed on concave portions which are formed between tracks.

<1> An optical recording medium which is provided with a first substrate, a first information layer, an intermediate layer, and a second information layer formed in this order as viewed from the laser beam irradiation side, wherein the second information layer is provided with a second dye recording layer, a dielectric layer, and a reflective layer formed in this order as viewed from the laser beam irradiation side; and the dielectric layer contains any one of materials selected from the group consisting of oxides, nitrides, sulfides, carbides or mixtures thereof from any one of elements which are not same as metal elements and semi-metal elements used for forming the reflective layer. <2> The optical recording medium according to the item <1>, wherein recording and reproducing is performed on each of the first information layer and the second information layer by laser beam irradiation from the first information layer side.

<3> The optical recording medium according to any one of the items <1> to <2>, wherein the material of the dielectric layer is a complex dielectric which contains one or more selected from the group consisting of ZnS, ZnO, TaS₂, and rare earth sulfides in an amount of 50 mole % to 90 mole % and a heat-resistant compound having high-transparency and any one of a melting point or a bifurcation point being 1,000° C. or more.

<4> The optical recording medium according to any one of the items <1> to <3>, wherein the dielectric layer has a thickness of 1 nm to 70 nm.

<5> The optical recording medium according to any one of the items <1> to <4>, wherein the first information layer is provided with a first dye recording layer and a translucent reflective layer formed in this order as viewed from the laser beam irradiation side.

<6> The optical recording medium according to any one of the items <1> to <5>, wherein the second information layer is provided with a protective layer, the second dye recording layer, the dielectric layer, and the reflective layer formed in this order as viewed from the laser beam irradiation side.

<7> The optical recording medium according to any one of the items <5> to <6>, wherein each of the first dye recording layer and the second dye recording layer contains one or more selected from the group consisting of tetraazaporphyrin dyes, cyanine dyes, azo dyes, and squarylium dyes.

<8> The optical recording medium according to any one of the items <5> to <7>, wherein the thickness of the second dye recording layer is 1.0 times to 2.0 times that of the first dye recording layer.

<9> The optical recording medium according to any one of the items <6> to <8>, wherein the protective layer contains ZnS.

<10> The optical recording medium according to the item <9>, wherein the protective layer further contains a transparent conductive oxide.

<11> The optical recording medium according to the item <10>, wherein the transparent conductive oxide is one or more selected from the group consisting of In₂O₃, ZnO, Ga₂O₃, SnO₂, Nb₂O₅, and InGaO₃.

<12> The optical recording medium according to any one of the items <6> to <11>, wherein the protective layer has a thickness of 10 nm to 300 nm.

<13> The optical recording medium according to any one of the items <1> to <12>, wherein the reflective layer contains any one of Ag and an Ag alloy and has a thickness of 100 nm to 200 nm.

### BRIEF DESCRIPTION OF DRAWINGS

FIG. 1 is a cross-sectional view exemplarily showing a structure of a DVD having two information layers.

FIG. 2 is a cross-sectional view exemplarily showing a laminar structure of the optical recording medium of the present invention.

FIG. 3 is a cross-sectional view exemplarily showing another laminar structure of the optical recording medium of the present invention.

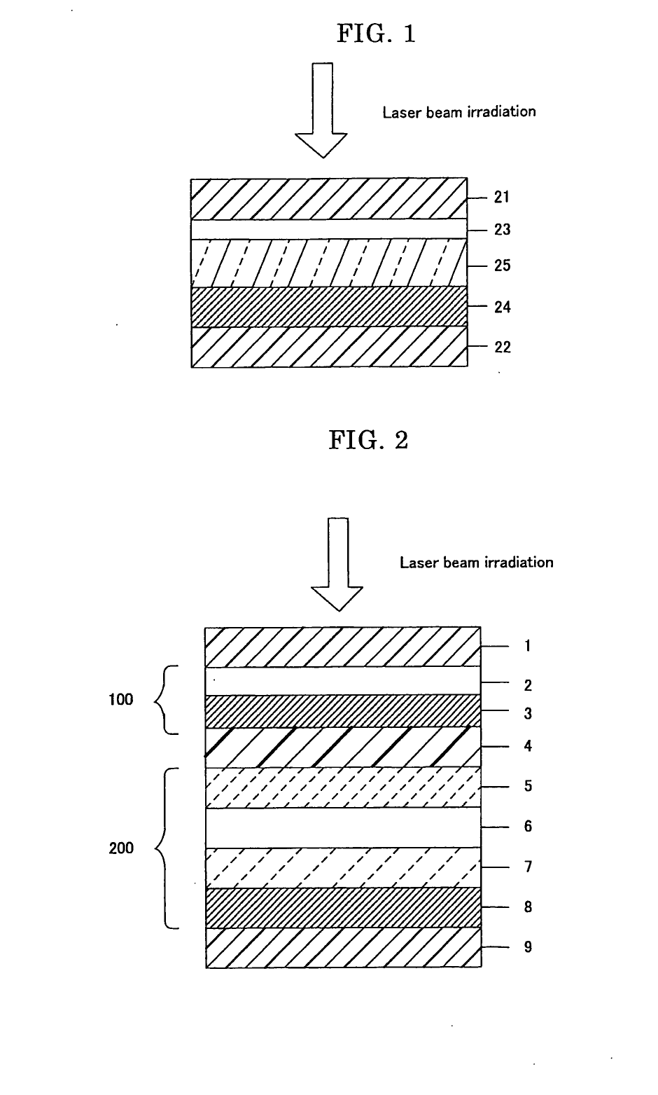

### BEST MODE FOR CARRYING OUT THE INVENTION

In the present invention, the optical recording medium having a first information layer and a second information layer is characterized in that a dielectric layer is formed between a reflective layer and a dye recording layer each constituting the second information layer which is disposed at the innermost side as viewed from the laser beam irradiation side, and a dye recording layer is made thin to thereby reduce cross-talk events caused at between adjacent tracks and then to enhance the recording property.

In typical DVD±R and two-layered optical recording media, as for a first recording layer disposed at the front side, a dye recording layer having a thickness of 60 nm to 100 nm is formed and coated on a groove having a groove depth of 100 nm to 200 nm, therefore, the thickness of the dye at groove portions on which information is recorded by irradiation of a laser beam is relatively thick, and the thickness of land portions with no information recorded thereon are thin, resulting in small thermal interference between adjacent groove portions. The greater the laser power used for recording is, the more thermal interference affects adjacent groove portions, which causes degradation in quality of signals i.e. jitter property. Thus, it is understood that as the recording speed increases, higher power is required and it is more easily affected by thermal interference.

In the laminar structure used in the present invention, in order to form a second dye recording layer disposed at the innermost side as viewed from the laser beam irradiation side of the optical recording medium, it is necessary to form a reflective layer on a substrate by sputtering, coat a dye recording layer on the reflective layer and form a protective layer by sputtering in the reverse order of that of conventional CD-R and DVD±R. Thus, among lands and grooves alternately arranged on the substrate, information is recorded on the land portions at the front side as viewed from the pick-up for recording and reproducing, namely, on convex portions on the substrate, therefore, thermal diffusion has impacts on the adjacent land portions more largely, and jitter property indicating quality of recording is liable to rise. For the reason, it is important to form a dielectric layer on a reflective layer, like the present invention, to thereby control optical pass length of recording laser beam and reduce the thickness of the dye recording layer as well as to control heat dissipation from the dye recording layer to the metal reflective layer, and with the configuration, it is possible to produce optical recording media suitable for higher recording speeds.

The thickness of the dielectric layer is preferably 1 nm to 70 nm, and more preferably 4 nm to 40 nm. When the thickness of the dielectric layer is less than 1 nm, only an ignorable difference in thermal property and optical property is induced, and there may be no difference in recording property, and when the thickness is more than 70 nm, it prevents heat generated at the recording layer by laser beam irradiation from escaping toward the reflective layer, and thus recording marks are excessively widen, resulting in degraded jitter property. In addition, it is difficult to have a reflectance of 15% or more at the information layer disposed at the innermost side, and a DVD reproducing player may be hardly turned on with such an optical recording medium.

Hereinafter, aspects of the optical recording medium of the present invention will be described referring to the figures.

FIG. 2 is a cross-sectional view exemplarily showing a laminar structure of the optical recording medium of the present invention. The optical recording medium is provided with first substrate 1, first dye recording layer 2, translucent reflective layer 3, intermediate layer 4, protective layer 5, second dye recording layer 6, dielectric layer 7, reflective layer 8, and second substrate 9. The first dye recording layer 2 and the translucent reflective layer 3 constitute first information layer 100, and the protective layer 5, the second dye recording layer 6, the dielectric layer 7, and the reflective layer 8 constitute second information layer 200.

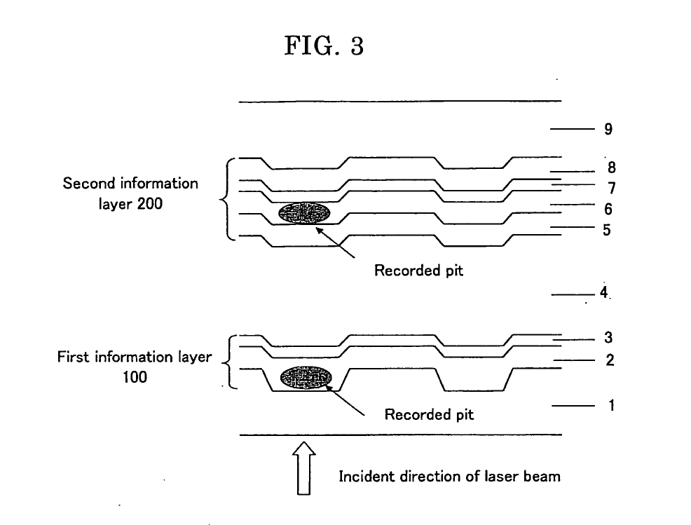

FIG. 3 is a cross-sectional view exemplarily showing another laminar structure of the optical recording medium of the present invention. The optical recording medium is provided with first substrate 1, first dye recording layer 2, translucent reflective layer 3, intermediate layer 4, protective layer 5, second dye recording layer 6, dielectric layer 7, reflective layer 8, and second substrate 9. The reference numeral 100 represents a first information layer, and the reference numeral 200 represents a second information layer.

With respect to the first information layer 100, by making the first information layer 100 have a similar laminar structure to those of conventional media having a single recording layer such as DVD+R and DVD-R where a first substrate with a first dye recording layer and a translucent reflective layer formed thereon is bonded to a singly formed second substrate, however, except for the singly formed substrate, multiple interference effect of both interfaces of the first dye recording layer 2 and deformation of the first substrate 1 at the time of forming marks are induced to thereby obtain a reflectance and a modulation degree of recording signals (contrast) necessary for the first information layer.

With respect to the second information layer 200, a reflectance and a modulation degree of recording signals (contrast) necessary for the second information layer are obtained by means of the groove shape on the second substrate 9 and optical absorption property of a dye or dyes, and by disposing the optically transparent protective layer 5 made from a hardly deformable material between the second dye recording layer 6 and the intermediate layer 4 made from an organic resin or the like, it is possible to prevent elution of the dye or dyes by effect from the organic resin as well as to form mark shapes property.

Preferred examples of materials of the first and second substrates include polycarbonate resins, acrylic resins, epoxy resins, polystyrene resins, acrylonitrile-styrene copolymer resins, polyethylene resins, polypropylene resins, silicone resins, fluorine resins, ABS resins, urethane resins, and transparent grass. Of these materials, polycarbonate resins and acrylic resins are preferably used in terms of superiority in optical properties and cost performance.

On both the first substrate and the second substrate, a groove having a track pitch for guiding recording and reproducing beams of 0.8 μm or less is formed, the groove is not necessarily formed in rectangular shape or in trapezoidal shape, those like waveguides having different refractive indexes may be formed to form a groove optically.

Each thickness of the first and second substrates can be changed to take chromatic aberration in accordance with the numerical aperture (NA) of the pick-up of the evaluation apparatus for use, and typically, each of the thicknesses of the first and second substrates is preferably 0.6 mm with a numerical aperture (NA) of 0.6 to 0.65.

In addition, each of the grooves formed on the first substrate 1 and the second substrate 9 are not in the same shape. In the case of DVD+R or DVD-R with storage capacity of 4.7 GB and a track pitch of 0.74 μm, the first substrate 1 preferably has a groove shape of a groove depth of 1,000 angstroms to 2,000 angstroms and a groove width or a bottom width of 0.2 μm to 0.3 μm. When a layer is prepared by spin-coating, there is a tendency that the groove is filled with a dye or dyes, and each interface surface of the dye recording layer and the reflective layer is determined depending on the fill ration and the groove shape of the substrate, therefore, in order to utilize the reflection of interface, the above-noted ranges on the groove shape are suitable.

On the other hand, the second substrate 9 preferably has a groove shape of a groove depth of 200 angstroms to 600 angstroms and a groove width of 0.2 μm to 0.4 μm. As shown in FIG. 2, since each interface shape of the dye recording layer and the reflective layer is determined depending on the groove shape of the substrate, in order to utilize the reflection of interface, the above-noted ranges on the groove shape are suitably used.

When both the first substrate 1 and the second substrate 9 respectively have a groove depth deeper than the above-noted range, the reflectance is liable to decrease. When both the first substrate 1 and the second substrate 9 respectively have a groove depth shallower than the above-noted range or a groove width deviated from the groove width range, tracking performance during recording is unstable, and the shape of recording marks to be formed are hardly uniformed, and jitter value easily increases.

Examples of the dye material used for the first dye recording layer 2 and the second recording layer 6 include cyanine dyes, phthalocyanine dyes, azo-metal chelate dyes, and squarylium dyes. The first and the second recording layers containing these dyes enable to easily form small marks and are compatible with high-density recording.

Each thickness of the first dye recording layer 2 and the second recording layer 6 is preferably 30 nm to 150 nm. When the thickness is less than 30 nm, sufficient contrast is hardly obtained, and the modulation tends to be reduced. On the other hand, when the thickness is more than 150 nm, small recording marks are hardly recorded.

In addition, at high-density recording as in recording in which the shortest mark length is 0.5 μm or less, the thickness of the first dye recording layer 2 and the second recording layer 6 is preferably 50 nm to 100 nm. When the thickness is less than 50 nm, it is unfavorable because the reflectance is excessively lowered, and the thickness is liable to be uneven. On the other hand, when the thickness is thicker than 100 nm, the thermal capacity is increased to cause degraded recording sensitivity, and the jitter value tends to be increased due to disturbed edges of recording marks caused by non-uniformity of thermal conductivity.

Typically, the first dye recording layer 2 and the second recording layer 6 are formed by spin-coating. Dye recording layers that have been subjected to spin-coating process are substantially uniform, afterward, deformation and optical holes of the dye recording layers and deformation of the substrates are induced by recording, and recording marks can be identified by changes in reflectance of these portions. Typically, reflectance difference between before and after recording is greater than 5%. It should be noted that when the first and the second dye recording layers are formed on a substrate with a guide groove formed thereon, there are differences in dye thickness between groove portions and inter-groove portions.

In the present invention, the thickness of the second dye recording layer 6 is preferably 1.0 time to 2.0 times that of the first dye recording layer 2. When the thickness difference of these recording layers deviates from the range, it is difficult to record information on both the first and the second dye recording layers with a similar recording strategy or a similar emission pulse pattern of recording laser because of difference in ease of widening recording marks.

Hereinafter, materials used for each of the layers of the optical recording medium of the present invention will be described in detail.

Like DVD+R and CD-R, the optical recording medium of the present invention is configured to obtain high-reflectance by multiple-interference effect of both of the interfaces of the recording layers each containing a dye or dyes, and the dye recording layers need to have optical properties of a relatively large refractive index “n” and a relatively small absorption coefficient “k” in complex refractive index “n-ik” at a recording and reproducing wavelength λ. The values “n” and “k” are typically in the range of n>2 and 0.02<k<0.2 respectively, and preferably, the value “n” is 2.2 to 2.8, and the value “k” is 0.03 to 0.07. When the value “k” is less than 0.03, the recording sensitivity degrades because of small absorption of the recording laser beam, and when the value “k” is more than 0.07, the reflectance is reduced, and it is difficult, in the case of an optical recording medium having two recording layers, to adequately increase the reflectance of the recording layer disposed at the innermost side as viewed from the laser beam irradiation side. Such optical properties can be obtained by utilizing properties of long wavelength edges of light absorption band of dye layers. The optical recording medium of the present invention is compatible with red laser light beams at a wavelength of 600 nm to 800 nm, and the preferred recording and reproducing wavelength λ is 650 nm to 670 nm. When setting a configuration of the optical recording medium, the wavelength of a laser beam used for recording and reproducing may be determined from the above-noted wavelength range first, and then each material and thickness of the respective layers may be selected so as to satisfy the conditions of the present invention.

Examples of dye materials that can be used for the first dye recording layer 2 and the second dye recording layer 6 include tetraazaporphyrin dyes, cyanine dyes, phthalocyanine dyes, pyrylium dyes, thio-pyrylium dyes, azulenium dyes, squarylium dyes, azo dyes, formazanchelate dyes, metal complex salt dyes such as Ni and Cr, naphthoquinone dyes, anthraquinone dyes, indophenol dyes, indoaniline dyes, triphenyl methane dyes, triallyl methane dyes, aminium dyes, diimmonium dyes, and nitroso compounds. Of these, as dye compounds having the maximum absorption wavelength of light absorption spectrum ranging from 580 nm to 620 nm on layers and by which desired optical properties are easily obtainable at a wavelength of laser beams for DVD of around 650 nm, tetraazaporphyrin dyes, cyanine dyes, azo dyes, and squarylium dyes are preferable in consideration of layer formation by means of a solvent-coating and ease of control of optical properties.

In addition, the dye recording layers may be prepared by using only a dye or dyes, however, other third components such as a binder, and stabilizer may be contained in accordance with the necessity.

As for materials of the reflective layer 8 and the translucent reflective layer 3, materials exhibiting high reflectance with respect to the laser beam wavelength are preferably used, and examples thereof include metals and semi-metals such as Au, Ag, Cu, Al, Ti, V, Cr, Ni, Nd, Mg, Pd, Zr, Pt, Ta, W, Si, Zn. Of these, alloys containing any one of elements selected from the group consisting of Au, Ag, Cu, and Al as the main component and at least one element selected from Au, Ag, Cu, Al, Ti, V, Cr, Ni, Nd, Mg, Pd, Zr, Pt, Ta, W, Si, Zn, and In which are different from the above-noted four elements, in an amount of 0.5% by mass to 10% by mass are preferable. By adding the at least one element other than the above-noted four elements in an amount of 0.5% by mass or more, the reflective layer 8 and the translucent reflective layer 3 can be formed into thin layers which excel in resistance to corrosion, and the crystal grains thereof are micronized. However, when the at least one element other than the above-noted four elements is added in an amount more than 10% by mass, it is unfavorable because the reflectance is reduced.

The translucent reflective layer 3 is prepared so as to have a transmittance of 30% to 60% and a reflectance of 15% to 30% such that sufficient amount of laser beam reaches the second dye recording layer 6. The thickness of the translucent reflective layer 3 is preferably 5 nm to 30 nm.

The thickness of the reflective layer 8 is preferably 100 nm to 200 nm, and more preferably 130 nm to 200 nm. The reflective layer formed thickly is preferable in order to enhance heat dissipation property of the second information layer 200 disposed at the innermost side, however, when the thickness is more than 200 nm, it is unfavorable from the perspective of production cost because it takes a long time to form layers, and the material cost increases. In addition, microscopic flatness of the surfaces of the layers degrades.

When the first dye recording layer 2 and a transparent intermediate layer 4 containing an acrylic resin are formed in a laminar structure through an extremely thin translucent reflective layer having a thickness of 30 nm or less, there is a need to prevent the dye and the acrylic resin or the like from sinking into the translucent reflective layer 3 and being soluble each other. In the case of a translucent reflective layer made from a material of which the crystal grains are relatively large in size, as in thin layers made from pure metal, it is necessary to give attention because the thin layer is easily formed with unevenness like in island shape, and the resin easily sinks from the grain boundaries.

It is necessary to form the protective layer 5 between the second dye recording layer 6 and the intermediate layer 4 in order to chemically and physically protect the dye recording layer.

Examples of materials used for the protective layer 5 include oxides such as silicon oxides, indium oxides, tin oxides, zinc oxides, gallium oxides, niobium oxides, aluminum oxides, magnesium oxides, and tantalum oxides; semi-metals or semiconductor materials such as silicon, germanium, silicon carbides, titanium carbides, and graphites; fluorides such as magnesium fluorides, aluminum fluorides, lanthanum fluorides, and selenium fluorides; sulfides such as zinc sulfides, cadmium sulfides, and antimony sulfides; nitrides such as silicon nitrides, and aluminum nitrides; chalcogenide compounds such as ZnSe, GaSe, and ZnTe; or mixtures of the above-noted materials.

Particularly, materials containing a large amount of zinc sulfide, cadmium sulfide, antimony sulfide, and/or silicon oxide each of which has small internal stress are preferably used. Further, in order to optimize the refractive index “n” and the absorption coefficient “k”, mixtures of these materials may be used. These materials respectively have high-melting point, and when the materials mixed at the time of calcination of target do not react with each other, the values of “n” and “k” are substantially equal to the weighted average thereof corresponding to the mixture ratio.

Among the materials, when zinc sulfide which has relatively small toxic potency and high-sputtering rate and is inexpensive is mainly used, it is possible to increase the productivity and to reduce the production cost. The composition ratio of zinc sulfide is preferably 60 mole % to 95 mole %, and when the composition ratio is more than 95 mole %, a thin layer may not be properly deposited on the second dye recording layer 6. To control the refractive index “n”, it is desirable to determine the composition ratio of zinc sulfide to 95 mole % or less and to mix it with a material having a different refractive index from that of the zinc sulfide. When preparing a thin layer made from a mixture, plural targets can be subjected to a sputtering process at the same time, however, this is unfavorable because the production devices are costly, and it is difficult to control the ratio. Thus, it is advantageous to prepare a mixture target of zinc sulfide and added materials and then to be subjected to a sputtering process, from the perspective of productivity.

The refractive index “n” of zinc sulfide is around 2.35, and when a mixture of zinc sulfide with SiO₂ is used to obtain a refractive index lower than 2.35, it is possible to produce the protective layer with stable quality because targets used for commercially available CD-RW, DVD-RW, and DVD+RW can be used.

Further, by adding silicon, silicon carbide, titanium oxide, or germanium in an amount of 5 mole % or more, the refractive index “n” can be increased. When the added amount is less than 5 mole %, the effect of increasing the refractive index becomes small to an ignorable extent.

In particular, by adding a transparent conductive oxide such as indium oxide, zinc oxide, gallium oxide, tin oxide, niobium oxide, and InGaO₃ (ZnO)m (m is a positive integer) to the target material of the protective layer, DC sputtering is enabled because conductivity can be imparted to the target. The increased sputtering rate contributes to reduction in production tack and cost reduction of production devices. To enable to employ DC sputtering, the specific resistance of the target is required to be 1 Ωcm or less, and preferably, with a specific resistance of 0.1 Ωcm or less, it is possible to increase the productivity because there arises no problem with arc or the like even when high sputtering power is applied. Further preferably, with a specific resistance of 0.01 Ωcm or less, it is possible reduce the cost for production devices because the sputtering power source no longer needs arc-cut devices nor devices for superposing pulses. However, the stress of the protective layer 5 is increased, and exfoliation arises from the interface between the second dye recording layer 6 and the protective layer 5, and thus the maximum added amount of the transparent conductive oxides is determined as 30 mole %.

The thickness of the protective layer 5 is preferably 10 nm to 300 nm. When the thickness is less than 10 nm, the material of the intermediate layer sinks into the second dye recording layer 6 due to defect in the protective layer, causing denaturation of the dye. When the thickness is more than 300 nm, the stress of the protective layer 5 is increased because the raised temperature of the substrate during sputtering is excessively large, and therefore, it is liable to cause deformation of the substrate and exfoliation of the protective layer. Further, when the absorption coefficient “k” is not zero, reflectances of the dye recording layers are reduced by the light absorption.

When the wavelength of the recording laser beam is 600 nm to 700 nm, and the refractive index of the material of the protective layer 5 is 1.9 to 2.4, the thickness of the protective layer is preferably 40 nm to 160 nm, and more preferably 100 nm to 140 nm.

Basically, the case that the product between the refractive index “n” and the thickness “d” is similar is allowable. Namely, when the refractive index is set to be smaller, the thickness needs to be thicker than the thickness at the time when the original refractive index is employed. This is because the reflectance needs to be similar to those of other layers, and the variation of optical pass length (2×n×d) represents the phase difference, and therefore, with a protective layer formed in an extremely thin thickness, it is difficult to take a phase difference, namely, a modulation.

With respect to a material of the dielectric layer 7 to be formed on the reflective layer 8, the dielectric layer 7 is formed from any one of materials selected from the group consisting of oxides, nitrides, sulfides, carbides or mixtures thereof from any one of elements which are not same as metal elements and semi-metal elements used for forming the reflective layer.

Among these materials, complex dielectric materials containing one or more elements selected from the group consisting of ZnS, ZnO, TaS₂, and rare-earth sulfides in an amount of 50 mole % to 90 mole % and containing a heat-resistant compound having high-transparency and a melting point or a bifurcation point of 1,000° C. or more are preferably used. Particularly, complex dielectric materials containing ZnS and ZnO in an amount of 70 mole % to 90 mole % or containing rare-earth sulfides such as La, Ce, Nd, and Y in an amount of 60 mole % to 90 mole % are preferable.

Examples of the heat-resistant compound materials having high-transparency and a melting point and a bifurcation point of 1,000° C. or more include oxides, nitrides, and carbides of Mg, Ca, Sr, Y, La, Ce, Ho, Er, Yb, Ti, Zr, Hf, V, Nb, Ta, Zn, Al, Si, Ge, and Pb. The oxides, sulfides, nitrides, and carbides do not necessarily take a stoichiometric composition, and the composition can be controlled for controlling refractive index, or the like, and each of these materials can be mixed for use.

According to the present invention, it is possible to provide an optical recording medium having two information layers by forming a dielectric layer between a reflective layer and a dye recording layer each constituting a second information layer disposed at the innermost side as viewed from the laser beam irradiation side to make the dye recording layer thin to thereby reduce cross-talk events caused at between adjacent tracks and to enhance the recording property.

### EXAMPLE

Hereinafter, the present invention will be further described in detail referring to specific Examples and Comparative Examples, however, the present invention is not limited to the disclosed examples. For example, prepared optical recording media were evaluated under a recording and reproducing condition of a recording linear velocity of 8× DVD (linear velocity=30.6 m/sec), however, when the recording and reproducing condition is changed to further higher speeds, higher-speed recording and reproducing is enabled.

### Examples 1 to 26 and Comparative Examples 1 to 2

A polycarbonate substrate having a thickness of 0.57 mm with a concave groove having a groove depth of 160 nm, a groove width of 0.35 μm, and a track pitch of 0.74 μm formed thereon was spin-coated with a coating solution in which a squarylium dye compound represented by the following structural formula was dissolved in 2,2,3,3-tetrafluoropropanol to thereby form a first dye recording layer having a thickness around 40 nm on the polycarbonate substrate.

Further, the first dye recording layer was sputtered with an Ag alloy containing 0.5 atomic % of In to form a translucent reflective layer having a thickness of 9 nm on the first dye recording layer and then to obtain a first substrate with a first information layer formed thereon.

Next, on a polycarbonate substrate having a thickness of 0.6 mm with a convex groove having a groove depth of 34 nm, a groove width of 0.3 μm, and a track pitch of 0.74 μm formed thereon, an Ag reflective layer having a thickness described in Table 1-A and 1-B, and a dielectric layer having a thickness and formed with a material described in Table 1-A and 1-B were formed. The dielectric layer was spin-coated with a coating solution in which a squarylium dye compound represented by the following structural formula was dissolved in 2,2,3,3-tetrafluoropropanol to thereby form a second dye recording layer having a thickness of around 70 nm on the dielectric layer.

On the second dye recording layer, a protective layer having a thickness and formed with a material described in Table 1-A and 1-B to thereby obtain a second substrate with a second information layer formed thereon.

Next, the first substrate and the second substrate are bonded together with an ultraviolet curable adhesive being a resin intermediate layer (KARAYAD DVD576M, manufactured by Nippon Kayaku Co., Ltd.) such that the thickness of the intermediate layer was 50 μm, to thereby obtain an optical recording medium.

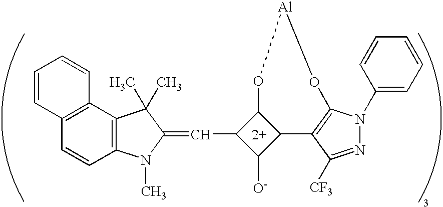

DVD (8-16) signals were recorded on the second dye recording layer of the thus obtained optical recording medium using ODU-1000 manufactured by PULSTEC INDUSTRIAL CO., LTD. with a wavelength of 657 nm and a lens numerical aperture (NA) of 0.65 at a linear velocity of 30.64 m/s (8× DVD). Then, the signals were reproduced at a linear velocity of 3.83 m/s to evaluate the results. Table 2-A and 2-B show the evaluation results. In Table 2-A and 2-B, “power margin” is a value determined by the following calculation with respect to a lower limit jitter power value P1 at which the jitter value is 9% or less, and an upper limit jitter power value P2.

(P2−P1)×2/(P2+P1)

In Table 2-A and 2-B, “Reflectance after recording” corresponds to “I14/I14H”, and “I14/I14H” is a modulation degree represented by the following equation.

I14/I14H=(I14H−I14L)/I14H

TABLE 1-A

| | | | | Refractive | | |
|---|---|---|---|---|---|---|
| | | Thickness of | | Index of | Thickness of | |
| | Composition of Lower | Lower | Composition of Upper | Upper | Upper | Thickness of |
| | Protective | Protective | Protective Layer | Protective | Protective | Reflective |
| | Layer (mole %) | Layer | (mole %) | Layer | Layer | Layer |
| Ex. 1 | ZnS(80)SiO₂(20) | 150 nm | SiO₂ | 1.5 | 15 nm | 120 nm |
| Ex. 2 | ZnS(80)SiO₂(20) | 150 nm | Si₃N₄ | 2.0 | 15 nm | 120 nm |
| Ex. 3 | ZnS(80)SiO₂(20) | 150 nm | SiC | 2.7 | 5 nm | 120 nm |
| Ex. 4 | ZnS(80)SiO₂(20) | 150 nm | ZnS | 2.4 | 15 nm | 120 nm |
| Ex. 5 | ZnS(80)SiO₂(20) | 150 nm | TiO₂ | 3.0 | 10 nm | 120 nm |
| Ex. 6 | ZnS(80)SiO₂(20) | 150 nm | SiO₂(80)Ta₂O₅(20) | 2.0 | 15 nm | 120 nm |
| Ex. 7 | ZnS(80)SiO₂(20) | 150 nm | Nb₂O₅(70)SiO₂(30) | 2.1 | 15 nm | 120 nm |
| Ex. 8 | ZnS(80)SiO₂(20) | 150 nm | TiC(70)TiO₂(30) | 2.4 | 5 nm | 120 nm |
| Ex. 9 | ZnS(80)SiO₂(20) | 150 nm | In₂O₃(90)SnO₂(10) | 2.0 | 15 nm | 120 nm |
| Ex. 10 | ZnS(80)SiO₂(20) | 150 nm | ZnS(70)ZnO(28)Ga₂O₃(2) | 2.2 | 15 nm | 120 nm |
| Ex. 11 | ZnS(80)SiO₂(20) | 150 nm | SnO₂(67)ZnO(25)In₂O₃(8) | 2.1 | 15 nm | 120 nm |
| Ex. 12 | ZnS(80)SiO₂(20) | 150 nm | ZnS(70)SiC(30) | 2.5 | 15 nm | 120 nm |
| Ex. 13 | ZnS(80)SiO₂(20) | 150 nm | ZnS(80)SiO₂(20) | 2.1 | 15 nm | 120 nm |
| Ex. 14 | ZnS(80)SiO₂(20) | 150 nm | ZnS(80)Si₃N₄(20) | 2.2 | 15 nm | 120 nm |
| Ex. 15 | ZnS(80)SiO₂(20) | 150 nm | Si₃N₄(90)TiC(10) | 2.3 | 10 nm | 120 nm |

TABLE 1-B

| | | | | Refractive | | |
|---|---|---|---|---|---|---|
| | | Thickness of | | Index of | Thickness of | |
| | Composition of Lower | Lower | Composition of Upper | Upper | Upper | Thickness of |
| | Protective | Protective | Protective Layer | Protective | Protective | Reflective |
| | Layer (mole %) | Layer | (mole %) | Layer | Layer | Layer |
| Ex. 16 | ZnS(80)SiO₂(20) | 150 nm | SnO₂(80)Ta₂O₅(20) | 2.0 | 1 nm | 120 nm |
| Ex. 17 | ZnS(80)SiO₂(20) | 150 nm | SnO₂(80)Ta₂O₅(20) | 2.0 | 50 nm | 120 nm |
| Ex. 18 | ZnS(80)SiO₂(20) | 150 nm | SnO₂(80)Ta₂O₅(20) | 2.0 | 70 nm | 120 nm |
| Ex. 19 | ZnS(80)SiO₂(20) | 150 nm | SnO₂(80)Ta₂O₅(20) | 2.0 | 15 nm | 80 nm |
| Ex. 20 | ZnS(80)SiO₂(20) | 150 nm | SnO₂(80)Ta₂O₅(20) | 2.0 | 15 nm | 200 nm |
| Ex. 21 | ZnS(80)SiO₂(20) | 150 nm | ZnS(90)(InGaO₃(ZnO)₄)(10) | 2.3 | 10 nm | 120 nm |
| Ex. 22 | ZnS(70)ZnO(30) | 150 nm | SnO₂(80)Ta₂O₅(20) | 2.0 | 15 nm | 120 nm |
| Ex. 23 | ZnS(70)ZnO(28)Ga₂O₃(2) | 150 nm | SnO₂(80)Ta₂O₅(20) | 2.0 | 15 nm | 120 nm |
| Ex. 24 | ZnS(70)In₂O₃(27)SnO₂(3) | 150 nm | SnO₂(80)Ta₂O₅(20) | 2.0 | 15 nm | 120 nm |
| Ex. 25 | ZnS(70)Nb₂O₅(30) | 150 nm | SnO₂(80)Ta₂O₅(20) | 2.0 | 15 nm | 120 nm |
| Ex. 26 | ZnS(90)(InGaO₃(ZnO)₄)(10) | 150 nm | SnO₂(80)Ta₂O₅(20) | 2.0 | 15 nm | 120 nm |
| Compara. | ZnS(70)ZnO(30) | 150 nm | — | — | — | 120 nm |
| Ex. 1 | | | | | | |
| Compara. | ZnS(80)SiO₂(20) | 150 nm | SnO₂(80)Ta₂O₅(20) | 2.0 | 75 nm | 120 nm |
| Ex. 2 | | | | | | |

TABLE 2-A

| | Optimum | | | Reflectance | |
|---|---|---|---|---|---|
| | recording | Bottom | Power | after | |
| | power | Jitter | margin | recording | |
| | (mW) | (%) | (%) | (%) | I14/I14H |
| Ex. 1 | 38 | 7.2 | 20 | 19.0 | 0.75 |
| Ex. 2 | 40 | 7.5 | 25 | 19.5 | 0.75 |
| Ex. 3 | 43 | 8.0 | 17 | 19.0 | 0.80 |
| Ex. 4 | 41 | 7.8 | 18 | 18.0 | 0.70 |
| Ex. 5 | 39 | 7.9 | 20 | 18.5 | 0.78 |
| Ex. 6 | 39 | 7.5 | 19 | 19.2 | 0.77 |
| Ex. 7 | 40 | 7.5 | 18 | 19.5 | 0.77 |
| Ex. 8 | 42 | 7.9 | 18 | 18.0 | 0.77 |
| Ex. 9 | 39 | 8.0 | 19 | 19.7 | 0.74 |
| Ex. 10 | 40 | 7.8 | 22 | 16.0 | 0.75 |
| Ex. 11 | 39 | 7.3 | 25 | 19.5 | 0.70 |
| Ex. 12 | 38 | 7.6 | 20 | 20.0 | 0.72 |
| Ex. 13 | 40 | 8.0 | 20 | 19.0 | 0.72 |
| Ex. 14 | 39 | 8.0 | 18 | 19.5 | 0.75 |
| Ex. 15 | 42 | 7.8 | 18 | 20.0 | 0.68 |

TABLE 2-B

| | Optimum | | | Reflectance | |
|---|---|---|---|---|---|
| | recording | Bottom | Power | after | |
| | power | Jitter | margin | recording | |
| | (mW) | (%) | (%) | (%) | I14/I14H |
| Ex. 16 | 44 | 8.2 | 12 | 17 | 0.6 |
| Ex. 17 | 45 | 8.4 | 10 | 21 | 0.64 |
| Ex. 18 | 47 | 8.5 | 10 | 21 | 0.62 |
| Ex. 19 | 38 | 7.9 | 10 | 18 | 0.75 |
| Ex. 20 | 42 | 7.7 | 12 | 20 | 0.68 |
| Ex. 21 | 42 | 7.8 | 20 | 20 | 0.70 |
| Ex. 22 | 40 | 7.5 | 22 | 19 | 0.74 |
| Ex. 23 | 40 | 7.6 | 22 | 19 | 0.75 |
| Ex. 24 | 40 | 7.8 | 20 | 19 | 0.75 |
| Ex. 25 | 40 | 7.5 | 22 | 19 | 0.76 |
| Ex. 26 | 40 | 7.6 | 21 | 19 | 0.75 |
| Compara. | 45 | 8.7 | 3 | 17 | 0.57 |
| Ex. 1 | | | | | |
| Compara. | 50 | 8.9 | 2 | 20.5 | 0.60 |
| Ex. 2 | | | | | |

As can be seen from Table 2-A and 2-B, each of the optical recording media of Examples 1 to 26 showed excellent recording properties and had a reflectance of 16% or more. However, the optical recording medium of Comparative Example 1 which was produced without forming an upper protective layer, and the optical recording medium of Comparative Example 2 which had an upper protective layer having a thickness more than 70 nm did not have a low jitter value respectively, and the power margin thereof was very small.

### INDUSTRIAL APPLICABILITY

The optical recording medium according to the present invention is particularly suitably used for two-layered recordable DVD (Digital Video Discs or Digital Versatile Disc) having two information layers.

1. An optical recording medium comprising:
a first substrate,
a first information layer,
an intermediate layer, and
a second information layer formed in this order as viewed from the laser beam irradiation side,
wherein the second information layer comprises a second dye recording layer, a dielectric layer, and a reflective layer formed in this order as viewed from the laser beam irradiation side; and the dielectric layer comprises any one of materials selected from the group consisting of oxides, nitrides, sulfides, carbides or mixtures thereof from any one of elements which are not same as metal elements and semi-metal elements used for forming the reflective layer.

2. The optical recording medium according to claim 1, wherein recording and reproducing is performed on each of the first information layer and the second information layer by laser beam irradiation from the first information layer side.

3. The optical recording medium according to claim 1, wherein the material of the dielectric layer is a complex dielectric which comprises one or more selected from the group consisting of ZnS, ZnO, TaS₂, and rare earth sulfides in an amount of 50 mole % to 90 mole % and a heat-resistant compound having high-transparency and any one of a melting point or a bifurcation point being 1,000° C. or more.

4. The optical recording medium according to claim 1, wherein the dielectric layer has a thickness of 1 nm to 70 nm.

5. The optical recording medium according to claim 1, wherein the first information layer comprises a first dye recording layer and a translucent reflective layer formed in this order as viewed from the laser beam irradiation side.

6. The optical recording medium according to claim 1, wherein the second information layer comprises a protective layer, the second dye recording layer, the dielectric layer, and the reflective layer formed in this order as viewed from the laser beam irradiation side.

7. The optical recording medium according to claim 5, wherein each of the first dye recording layer and the second dye recording layer comprises one or more selected from the group consisting of tetraazaporphyrin dyes, cyanine dyes, azo dyes, and squarylium dyes.

8. The optical recording medium according to claim 5, wherein the thickness of the second dye recording layer is 1.0 times to 2.0 times that of the first dye recording layer.

9. The optical recording medium according to claim 6, wherein the protective layer comprises ZnS.

10. The optical recording medium according to claim 9, wherein the protective layer further comprises a transparent conductive oxide.

11. The optical recording medium according to claim 10, wherein the transparent conductive oxide is one or more selected from the group consisting of In₂O₃, ZnO, Ga₂O₃, SnO₂, Nb₂O₅, and InGaO₃.

12. The optical recording medium according to claim 6, wherein the protective layer has a thickness of 10 nm to 300 nm.

13. The optical recording medium according to claim 1, wherein the reflective layer comprises any one of Ag and an Ag alloy and has a thickness of 100 nm to 200 nm.
